(19) United States
(12) Patent Application Publication
(10) Pub. No.: US 2011/0078531 A1
(43) Pub. Date: Mar. 31, 2011

(54) RADIO COMMUNICATION APPARATUS, RADIO COMMUNICATION SYSTEM, AND RADIO COMMUNICATION METHOD IN RADIO COMMUNICATION SYSTEM

(75) Inventors: Masataka UMEDA, Kawasaki (JP); Naoyuki Saitou, Kawasaki (JP)

(73) Assignee: FUJITSU LIMITED, Kawasaki-shi (JP)

(21) Appl. No.: 12/893,620

(22) Filed: Sep. 29, 2010

(30) Foreign Application Priority Data
Sep. 30, 2009 (JP) 2009-227264

(51) Int. Cl. H04L 1/18; G06F 11/00

(52) U.S. Cl. 714/751; 714/748; 714/E11.001

(57) ABSTRACT

A radio communication apparatus for performing radio communicate with other radio communication apparatus, the radio communication apparatus including: a quality measuring unit which measures reception quality of reception signal which is received from the other radio communication apparatus; a first error detecting unit which detects an error of reception data included in the reception signal on the basis of the reception quality and a first threshold value; and a retransmission request signal generating unit which generates a retransmission request signal on the basis of an error detection result of the first error detection unit, and transmits the retransmission request signal to the other radio communication apparatus.

### CROSS-REFERENCE TO RELATED APPLICATIONS

This application is based upon and claims the benefit of priority of the prior Japanese Patent Application No. 2009-227264, filed on Sep. 30, 2009, the entire contents of which are incorporated herein by reference.

1. Field

The embodiments discussed herein are related to a radio communication apparatus, a radio communication system, and a radio communication method in a radio communication system.

2. Background

As a conventional art of a radio communication system, HARQ (Hybrid Automatic Repeat Request) is known for an effective recovery of transmission error (for example, “3GPP TS 25.308”, “3GPP TS 25.309”, and “ IEEE Std 802.16e™-2005”).

Another of the conventional art of the radio communication systems is discussed that a retransmission request signal generating unit outputs an ACK signal or NACK signal to a NACK signal counting unit on the basis of an error detection result by an error detecting unit; the NACK signal counting unit counts, in each transmission mode, a number of the NACK signal (that is, the number of data retransmissions) outputted by the retransmission request signal generating unit until the ACK signal is outputted thereby; and a table modifying unit compares a number of times of retransmission with a prescribed threshold value thereof, and modifies contents of a transmission mode table on the basis of the comparison result (Japanese Laid-open Patent Publication No. 2002-64424).

However, in HARQ, if an error detection process exceeds a certain time period, a return period from a transmission of packet to a reception of retransmission request is extended, and then it takes a long time until a reception side receives a retransmitted packet. In this case, retransmission delay increases on both a transmission side and the reception side in comparison with a case that the transmission error detection process does not exceed the certain time period. Also, there may be a case that the reception side cannot receive the retransmitted packet in the certain time period, therefore throughput is deteriorated.

Moreover, in Japanese Laid-open Patent Publication No. 2002-64424, period of the error detection process is not considered, therefore delay of the error detection process increases or the throughput deteriorates.

### SUMMARY

According to an aspect of the invention, a radio communication apparatus for performing radio communicate with other radio communication apparatus, the radio communication apparatus comprising: a quality measuring unit which measures reception quality of reception signal which is received from the other radio communication apparatus; a first error detecting unit which detects an error of reception data included in the reception signal on the basis of the reception quality and a first threshold value; and a retransmission request signal generating unit which generates a retransmission request signal on the basis of an error detection result of the first error detection unit, and transmits the retransmission request signal to the other radio communication apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration example of a radio communication system.

FIG. 2 illustrates a configuration example of a radio communication system.

FIG. 3 illustrates a configuration example of a radio communication system.

FIG. 4 illustrates a configuration example of a transmission apparatus.

FIG. 5 illustrates a configuration example of a reception apparatus.

FIG. 6 illustrates an example of a threshold value table.

FIG. 7 illustrates an example of a threshold value table.

FIG. 8 is a flow chart illustrating an operation example of an error detection process.

FIG. 9 is a flow chart illustrating an operation example of a threshold value correction process.

FIG. 10 illustrates a configuration example of a reception apparatus.

FIG. 11 illustrates a configuration example of a reception apparatus.

FIG. 12 is a flow chart illustrating an operation example of an error detection switching process.

FIG. 13 is a flow chart illustrating an operation example of an error detection switching process.

FIG. 14 illustrates a configuration example of a reception apparatus.

FIG. 15 illustrates an example of a threshold value table.

FIG. 16 illustrates an example of a threshold value table.

FIG. 17 illustrates a configuration example of a reception apparatus 300.

FIG. 18 illustrates a configuration example of a transmission apparatus 300.

FIG. 19 illustrates a configuration example of a reception apparatus 100.

### DESCRIPTION OF EMBODIMENTS

Embodiments to carry out the present invention are explained below.

### The First Embodiment

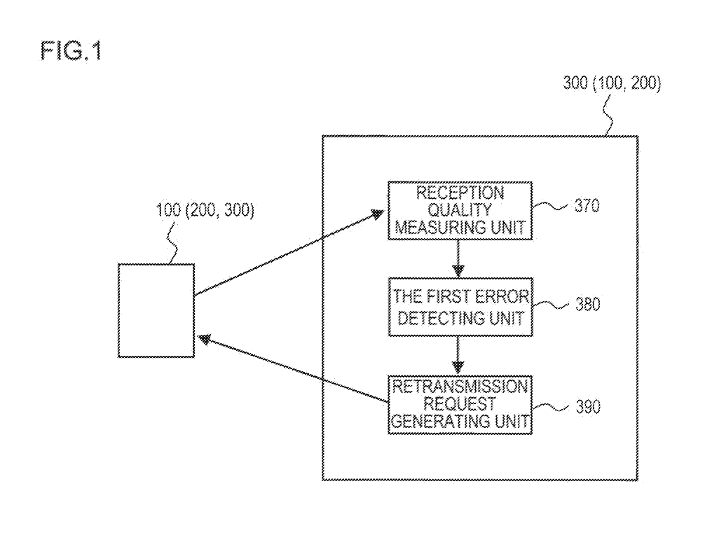

The first embodiment is explained. FIG. 1 illustrates a configuration example of a radio communication apparatus 300 of the first embodiment.

The radio communication apparatus 300 for performing radio communication with another radio communication apparatus 100, includes a reception quality measuring unit 370 which measures a transmission quality of reception signal received from the other radio communication apparatus 100, a first error detecting unit 380 which detects an error included in the reception signal on the basis of the transmission quality and a first threshold value, and a retransmission request signal generating unit 390 which generates retransmission request signal on the basis of the detection result by the first error detecting unit 380 and transmits the retransmission request signal to the other radio communication apparatus 100.

The reception quality measuring unit 370 measures the transmission quality of the reception signal, and the first error detecting unit 380 detects the error of reception data on the basis of the transmission quality and the first threshold value. Therefore, compared with a case of performing an error correction decode process of the reception signal and performing an error detection process on the basis of CRC code after the error correction decode process, this radio communication apparatus 300 can accelerate the error detection process by not performing the error correction decode process and the rest. Also, by accelerating the error detection process, the radio communication apparatus 300 can receive larger amount of data in a certain time period compared with the case of performing the error correction decode process by a CRC code or the like, thus enhance the throughput.

Further, the radio communication apparatus can be in practice as any of a base station apparatus 100, a mobile station apparatus 300, or a relay station apparatus 200, and also the other radio communication apparatus can be in practice as any of a base station apparatus 100, a mobile station apparatus 300, or a relay station apparatus 200.

### The Second Embodiment

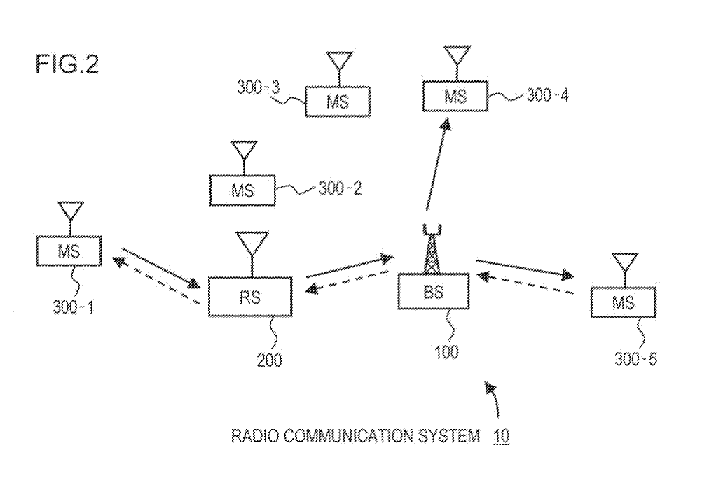

Here, the second embodiment will be explained. FIG. 2 illustrates a configuration example of a radio communication system 10 of the second embodiment. The radio communication system 10 includes the base station apparatus (refereed to as the “base station” hereinafter) 100, the relay station apparatus (refereed to as the “relay station” hereinafter) 200, and the mobile station apparatuses (referred to as the “mobile stations” hereinafter) 300-1 to 300-5.

The base station 100 can perform radio communication directly with the mobile stations 300-4 and 300-5, and can perform radio communication via the relay station 200 with the mobile stations 300-1 and the rest. For example, the mobile station 300-5 transmits retransmission request, and the base station can transmit transmission data (retransmission data) to the mobile station 300-5 on the basis of the retransmission request. Or, the mobile station 300-1 transmits the retransmission request to the mobile station 300-1 via the relay station 200, and the mobile station 300-1 can transmit the retransmission data via the relay station 200. Transmission directions of the retransmission request and retransmission data may be reverse to the directions illustrated in FIG. 2.

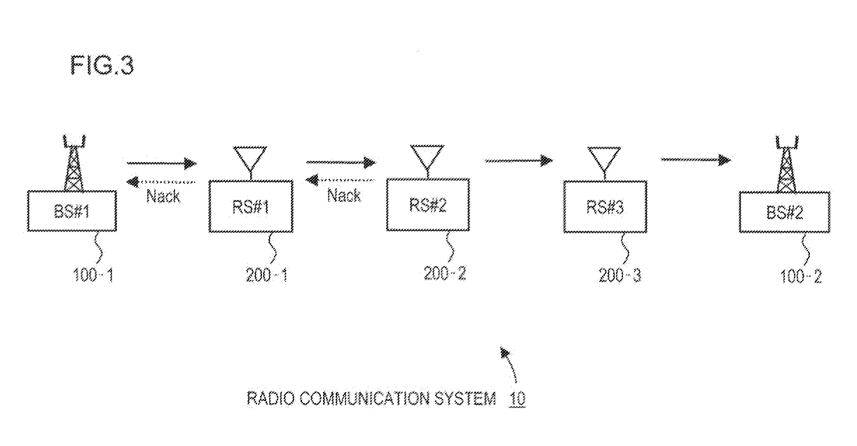

FIG. 3 illustrates another configuration example of the radio communication system 10. The radio communication system 10 includes a base station (BS #1) 100-1 as the transmission side, the base station 100 (BS #2) as the reception side, and a plurality of relay stations (RS #1 to RS #3) 200-1 to 200-3 on the radio communication paths thereof.

The base station 100-1 transmits a transmission data to the relay station 200-2 via the relay station 200-1. The relay station 200-2 confirms an occurrence of an error of the transmission data and transmits the retransmission request (for example, Nack). The retransmission request is transmitted via the relay station 200-1 to the base station 100-1. The base station 100-1 transmits the retransmission data on the basis of the retransmission request. In this case, the relay station 200 does not transmit to the relay station 200-3 the packet in which an error occurred. The radio communication system 100, for example, can adopt a multi-hop communication via the plurality of relay stations 200-1 to 200-3. Here, the number of the base station 100, relay stations 200, and the mobile stations 300 illustrated in FIG. 2 and FIG. 3 can be modified arbitrarily.

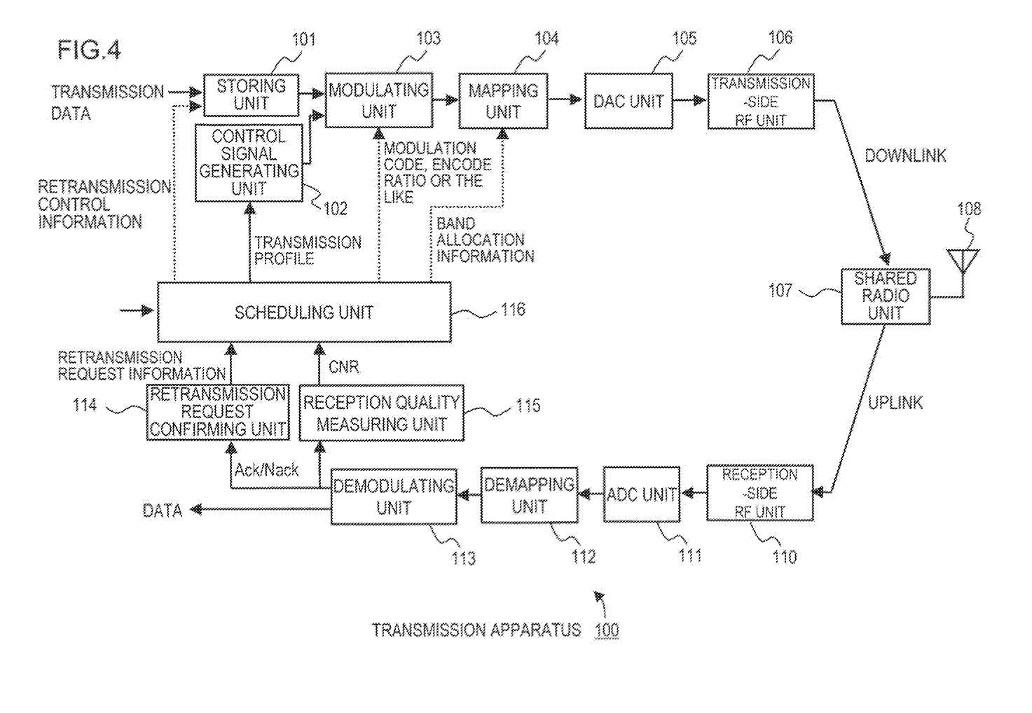

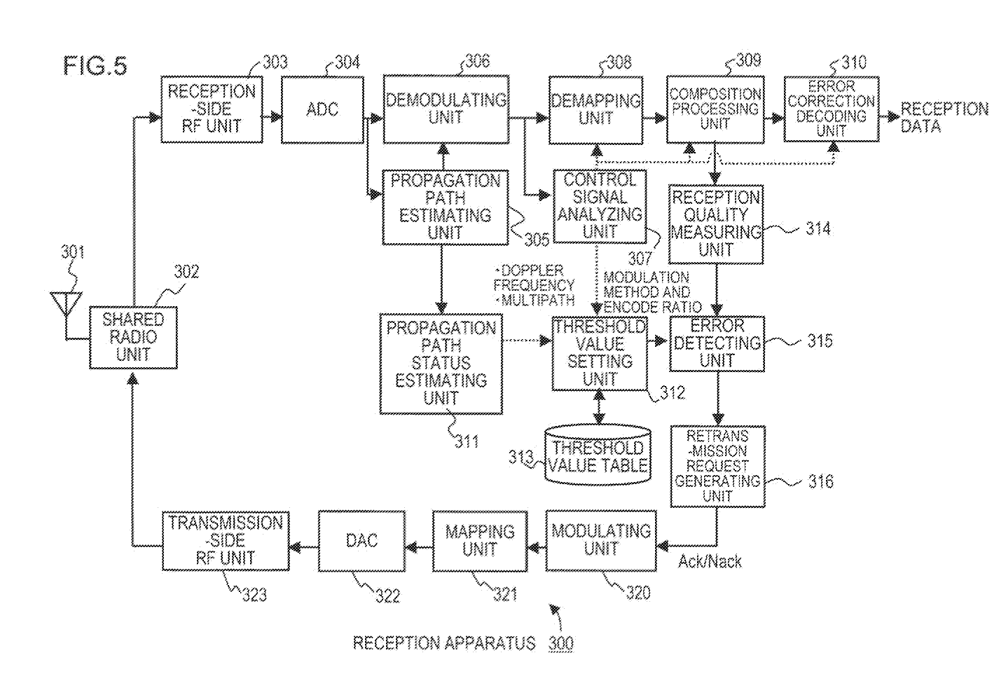

Next, the configuration example of each of the base station 100, the relay station 200, and the mobile station 200 as the configuration example of the radio communication apparatus will be explained. FIG. 4 illustrates a configuration example of a transmission apparatus, and FIG. 5 illustrates a reception apparatus. In the second embodiment, a case is explained such that the transmission apparatus is the base station 100 and the reception apparatus is the mobile station 300. As for same downlink, either of the cases can be in practice, such that the transmission apparatus is the base station 100 and the reception apparatus is the relay station 200, or that the transmission apparatus is the relay station 200 and the reception apparatus is the mobile station 300. A configuration example of uplink will be explained as the sixth embodiment.

The transmission apparatus (the base station 100) includes a storing unit 101, a control signal generating unit 102, a modulating unit 103, a mapping unit 104, a DAC unit 105, a transmission side RF unit 106, a shared radio unit 107, an antenna 108, a reception side RF unit 110, an ADC unit 111, a demapping unit 112, a demodulating unit 113, a retransmission request confirming unit 114, a reception quality measuring unit 115, and a scheduling unit 116.

The storing unit 101 stores the transmission data. And the storing unit 101 confirms whether or not the transmission data is for retransmission on the basis of retransmission control information output from the scheduling unit 116, and outputs the stored retransmission data if the transmission data is for transmission, or new transmission data if the transmission data is not for retransmission.

The control signal generating unit 102 generates, on the basis of a transmission profile (for example, a modulation signal, a modulation method, an encode ratio, a band allocation information, a retransmission control information or the like) scheduled by the scheduling unit 116, control signal including these information.

The modulating unit 103 modulates the transmission data output from the storing unit 101 and the control signal output from the control signal generating unit 102. The modulating unit 103 performs such modulation process as an error correction modulation or the like to the transmission data or the like according to the modulation method, the encode ratio or the like scheduled by the scheduling unit 116.

The mapping unit 104 allocates a band to the modulated transmission data or the like according to the band allocation information scheduled by the scheduling unit 116. For example, the mapping unit 104 allocates the transmission data or the like to each region of a time and frequency.

The DAC unit 105 converts the mapped transmission data or the like into analogue transmission data or the like.

The transmission side RF unit 106 performs various RF processes such as an amplification process, up-conversion process, or the like, to the analogue data or the like and outputs as transmission signal.

The shared radio unit 107 outputs to the antenna 108 the transmission signal output from the transmission side RF unit 106, or outputs to the reception side RF unit reception signal received from the antenna 108.

The antenna 108 transmits the transmission signal as radio signal to the reception apparatus (the mobile station 300), receives the radio signal transmitted from the reception apparatus 300, and outputs to the shared radio unit 107 as the reception signal.

The reception side RF unit 110 performs various RF processes such as a down-conversion or the like to the reception signal output from the shared radio unit 107.

The ADC unit 111 converts the reception signal output from the reception side RF unit 110 into digital signal.

The demapping unit 112, for example, performs a process to the digital signal output from the ADC unit 111 to subtract the reception data transmitted from the reception apparatus 300, according to the band allocation information determined by the scheduling unit 116 or the like.

The demodulating unit 113 performs a demodulation process to the output from the demapping unit 112. The demodulating unit 113, for example, outputs the demodulated reception data to the other unit such as the decoding unit at the subsequent part, and outputs the retransmission request signal to the retransmission request confirming unit 114, and pilot signal (or prescribed signal, or preamble signal) to the reception quality measuring unit 115, respectively.

The retransmission request confirming unit 114 confirms the retransmission request signal (Ack signal or Nack signal), and outputs retransmission request information to the scheduling unit 116.

The reception quality measuring unit 115 measures the reception quality (for example, CNR (Carrier to Noise Ratio) or the like) on the basis of, for example, the pilot signal or the like, and outputs measurement result to the scheduling unit 116. The reception quality measuring unit 115 measures, for example, transmission quality (or reception quality) detected after the demodulation process and before the decode process, or transmission quality (or reception quality) by the reception process performed before the decode process.

The scheduling unit 116 determines the transmission profile on the basis of the measurement result of the reception quality and of various scheduling information or the like. Also, the scheduling unit 116 outputs the retransmission control information to the storing unit 101, according to the retransmission request information.

The reception apparatus 300 includes an antenna 301, a shared radio unit 302, a reception side RF unit 303, an ADC unit 304, a propagation path estimating unit 305, a demodulating unit 306, a control signal analyzing unit 307, a demapping unit 308, a composition processing unit 309, an error correction decoding unit 310, a propagation path status estimating unit 311, a threshold value setting unit 312, a threshold value table 313, a reception quality measuring unit 314, an error detecting unit 315, a retransmission request generating unit 316, a modulation processing unit 320, a mapping unit 321, a DAC unit 322, and a transmission side RF unit 323.

For example, the reception quality measuring unit 314 corresponds to the reception quality measuring unit 370 of the first embodiment, the error detecting unit 315 corresponds to the first error detecting unit 380 of the first embodiment, and the retransmission request generating unit 316 corresponds to the retransmission request signal generating unit 390 of the first embodiment.

The antenna 301 transmits to and receives from the transmission apparatus 100 the radio signal.

The shared radio unit 302 outputs radio signal output from the antenna 301 to the reception side RF unit 303, and outputs the radio signal output from the transmission side RF unit 323 to the antenna 301.

The reception side RF unit 303 performs to the radio signal output from the shared radio unit 302 various types of processes such as a power amplification process, quadrature modulation process or the like, and outputs the reception signal.

The ADC unit 304 converts the reception signal output from the reception side RF unit 303 into digital signal.

The propagation path estimating unit 305 performs an estimation of the propagation path on the basis of, for example, the pilot signal or the like of digital signal output from the ADC unit 304, and outputs the propagation path estimation information to the demodulating unit 306 and the propagation path status estimating unit 311.

The demodulating unit 306 performs to the digital signal output from the ADC unit 304 a demodulation process such as a propagation path compensation process or the like on the basis of the propagation path estimation information.

The control signal analyzing unit 307 extracts the control signal from the demodulated reception data or the like, and extracts the transmission profile (the band allocation information, the modulation method, the encode ratio, the retransmission control information or the like) included in the control signal. The control signal analyzing unit 307 outputs, for example, the band allocation information to the demapping unit 308, the retransmission control information to the composition processing unit 309, and the modulation method and the encode ratio to the threshold value setting unit 312.

The demapping unit 308 extracts the reception data for the reception apparatus 300 from the demodulated reception signal, according to the band allocation information.

The composition processing unit 309 performs a maximum ratio composition with the reception data output from the demapping unit 308 and reception data subject to the retransmission request which is held, if the retransmission control information indicates the retransmission data. The composition processing unit 309 outputs, for example, the reception data output from the demapping unit 308 without performing the composition process, if the retransmission control information indicates new data.

The error correction decoding unit 310 performs an error correction decode process to the reception data output form the composition processing unit 309, according to the encode ratio or the like output from the control signal analyzing unit 307, and outputs the reception data.

The propagation path status estimating unit 311 generates Doppler frequency and multi path status or the like with respect to the propagation path (referred to as a “propagation path information” hereinafter), according to the propagation path estimation information, and outputs to the threshold value setting unit 312.

The threshold value setting unit 312 sets an error detection threshold value which is used for the error detection by the error detecting unit 315, on the basis of the propagation path information and the transmission profile (for example, the modulation method, the encode ratio, and the like). The threshold value setting unit 312, for example, selects any of the plurality of tables stored in the threshold value table 313 on the basis of the propagation path information, and reads out the error threshold value from the selected table on the basis of the modulation method, the encode ratio or the like. The threshold value to be set, for example, is determined on the basis of the propagation path information, the modulation method or the like, so as to be adopted to the robustness of the reception data (or ease of error).

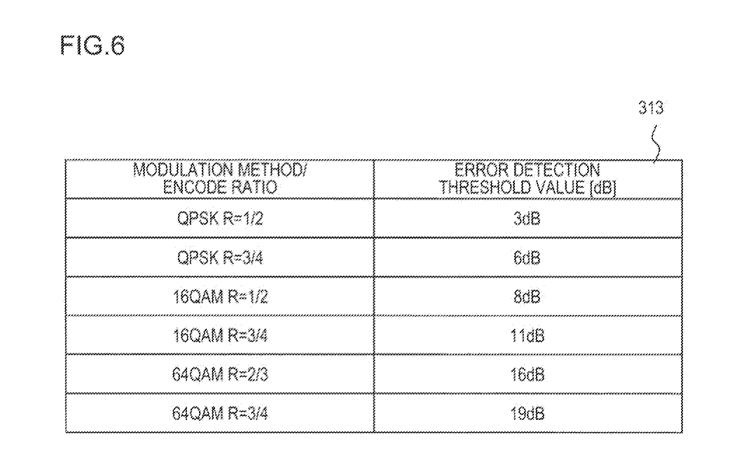

FIG. 6 illustrates an example of the threshold value table 313. The threshold value table 313 stores “error detection threshold value” according to “modulation method/encode ratio”. For example, when the modulation method and encode ratio are “QPSK” and “1/2” respectively, the error detection threshold value is “3 dB”, and when the modulation method and encode ratio are respectively “64QAM” and “3/4” respectively, the error detection threshold value is “19 dB”. In the example of FIG. 6, the reception signal by the modulation method being “QPSK” and the encode ratio being “1/2” is a reception signal transmitted from the transmission apparatus 100 under a poor propagation path condition, compared with the reception signal by the modulation method being “64QAM” and the encode ratio being “3/4”. The “error detection threshold value” at the case of “QPSK” or the like is low value compared with the case of “64QAM” or the like. Therefore, even under poor propagation path condition, the reception apparatus 300 does not transmit the Nack, if the reception apparatus 300 can receive the data or the like which is greater than the error detection threshold value.

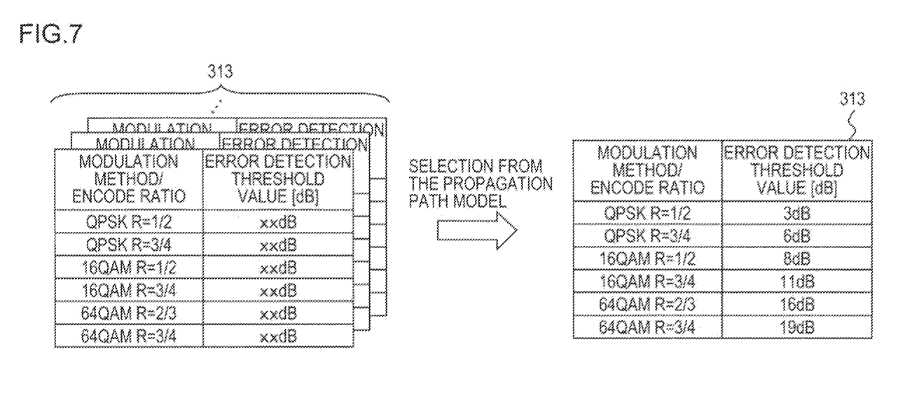

FIG. 7 illustrates an example of selecting any of a plurality of the threshold value tables 313 on the basis of a propagation path model (or the propagation path information). For example, the threshold value table 313 stores a plurality of tables, and the threshold vale setting unit 312 selects any one of the threshold value tables 313 on the basis of the Doppler frequency, multi path status, or the like.

To return to FIG. 5, the reception quality measuring unit 314 measures the reception quality of the reception data, the pilot signal or the like output from the composition processing unit 314. The reception quality measuring unit 314 measures, for example, EVM (Error Vector Magnitude), CINR (Carrier to Interference plus Noise Ratio), or the like, of the reception data or the like. The reception quality measuring unit 314 measures, for example, the transmission quality (or the reception quality) detected after the demodulation process and before the decode process, or the transmission quality (or the reception quality) by the reception process performed before the decode process.

The error detecting unit 315 compares the reception quality measured by the reception quality measuring unit 314 with the threshold value set by the threshold value setting unit 315, and detects an error of the reception signal. The error detecting unit 315 outputs the detection result to the retransmission request generating unit 316. The detail of this will be explained later.

The retransmission request generating unit 316 generates the retransmission request signal (the Ack signal or the Nack signal) on the basis of the error detection result. The retransmission request generating unit 316 generates, for example, the Nack signal in a case of the detection result indicating occurrence of error, or the Ack signal in a case of the detection result indicating non occurrence of error.

The modulating unit 320 performs the modulation process to the retransmission request signal, for example, according to the control signal analyzed by the control signal analyzing unit 307.

The mapping unit 321 allocates the band (for example, in the directions of time and frequency) to the modulated retransmission request signal, for example, according to the control signal analyzed by the control signal analyzing unit 307.

The DAC unit 322 converts the retransmission request signal after the band allocation into digital signal.

The transmission side RF unit 323 performs various RF processes such as the up-conversion process, the amplification process or the like, to the retransmission request signal after converting into the digital signal, and outputs to the shared radio unit 302.

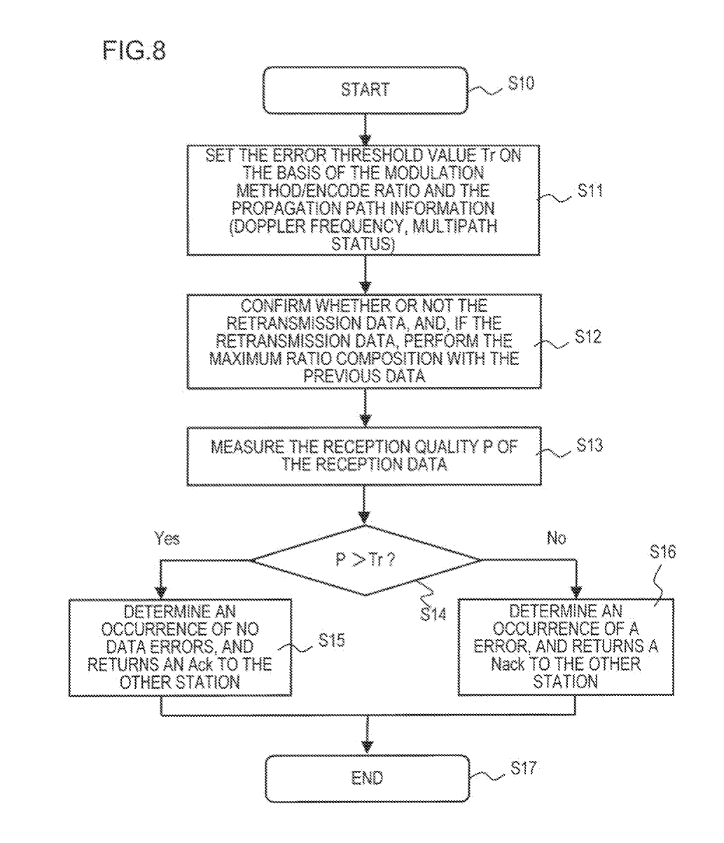

Next, operations will be explained. FIG. 8 is a flow chart illustrating an operation example of the error detection process by the reception apparatus 300.

The reception apparatus 300 starts the process (S10), and sets the error threshold value Tr on the basis of the modulation method and encode ratio of the reception data and on the basis of the propagation path information (S11). For example, the threshold value setting unit 312 sets the error threshold value Tr.

Next, the reception apparatus 300 confirms whether or not the reception data is the retransmission data, and performs the maximum ratio composition with the data subject to retransmission and the retransmission data in a case of the retransmission data. For example, the composition processing unit 309 determines whether or not the reception data is the retransmission data, on the basis of the retransmission control information, and, in case of the retransmission data, performs the maximum composition process with the data subject to retransmission which is held in the memory, and the retransmission data.

Next, the reception apparatus 300 measures the reception quality P of the reception data (S13). For example, the reception quality measuring unit 314 measures the reception quality P.

Next, the reception apparatus 300 compares the reception quality P with the error threshold value Tr, and determines whether or not the reception quality P is greater than the error threshold value Tr (S14). For example, the error detecting unit 315 performs this determination.

The reception apparatus 300 determines occurrence of no data error, if the reception quality P is determined to be greater than the error threshold value Tr (“Yes” at S14), and transmits the Ack signal to the transmission apparatus 100 (S15). For example, the error detecting unit 315 outputs detection result indicating the occurrence of no error to the retransmission request generating unit 316, and the retransmission request generating unit 316 generates the Ack signal. Then the Ack signal is transmitted to the transmission apparatus 100 via the modulating unit 320 or the like.

On the other hand, the reception apparatus 300 determines occurrence of data error if the reception quality P is determined to be less than or equal to the error threshold value Tr (“No” at S14), and transmits the Nack signal to the transmission apparatus 100 (S16). For example, the error detecting unit 315 outputs detection result indicating the occurrence of error to the retransmission request generating unit 316, and the retransmission request generating unit 316 generates the Nack signal. Then the Nack signal is transmitted to the transmission apparatus 100 via the modulating unit 320 or the like.

The reception apparatus 300 ends the series of processes (S17) after completing the processes of S15 and S16.

The transmission apparatus 100 transmits the new data to the reception apparatus 300 when receives the Ack signal, or transmits the retransmission data to the reception apparatus 300 when receives the Nack signal.

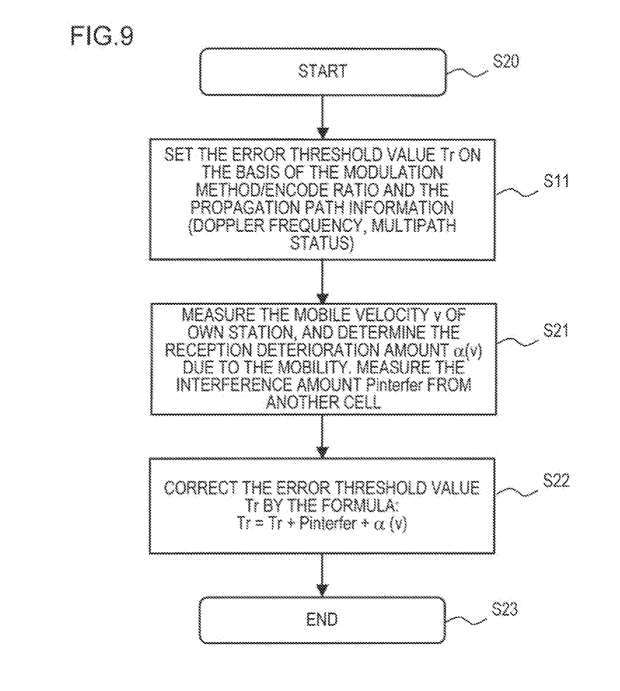

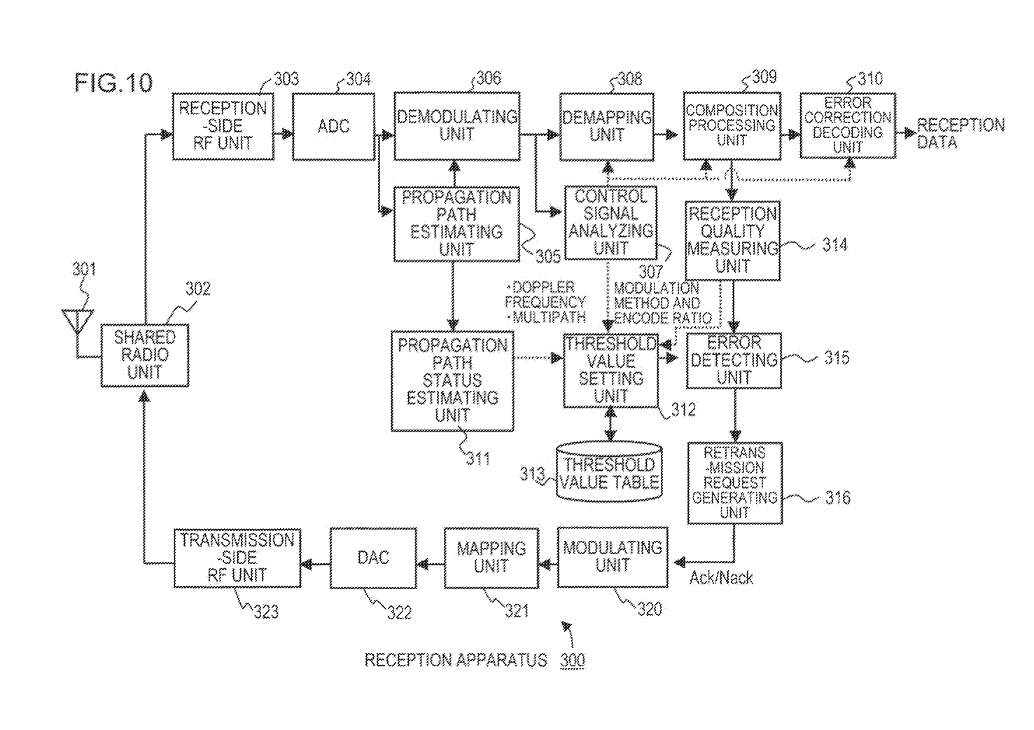

Here, the threshold value Tr can be corrected, considering an interference from another cell, a change of the propagation path or the like due to the mobility of the reception apparatus 300. FIG. 9 is a flow chart illustrating an operation example of the threshold value correction process, and FIG. 10 illustrates a configuration example of the reception apparatus 300 in case that the correction process is performed.

As for the reception apparatus 300, the reception quality measuring unit 314 further measures interference amount P_{interfer} from another cell, and outputs to the threshold value setting unit 312.

The operation example is as follows. Firstly, the reception apparatus 300 starts the process (S20), and sets the threshold value Tr (S11).

Next, the reception apparatus 300 measures its own mobile velocity v, calculates reception deterioration amount α(v) due to the mobility, and measures the interference amount P_{interfer} from another cell (S21). For example, the propagation path status estimating unit 311 measures the mobile velocity v of the own station on the basis of the calculated Doppler frequency, and calculates the reception deterioration amount α(v) (or reception gain deterioration amount of the reception apparatus 300 at the mobile velocity v) from the mobile velocity v. Here, the reception apparatus 300 can further includes GPS unit by which the mobile velocity is measured. And, for example, the reception quality measuring unit 314 calculates the interference amount P_{interfer} on the basis of the measured reception quality (the EVM, the CINR, or the like). The reception deterioration amount α(v) and the interference amount P_{interfer} are output to the threshold value setting unit 312.

Next, the reception apparatus 300 corrects the error threshold value Tr (S22). For example, the threshold value setting unit 312 corrects the threshold value Tr according to the following formula.

Tr=Tr+Pinterfer+α(v)

Then, the reception apparatus 300 ends the series of processes(S23). Thereafter, for example, the reception apparatus 300 performs the error detection by using the corrected threshold value Tr.

In this way, the reception apparatus 300 measures, for example, the reception quality by using the output from the composition processing unit 309 or the output after the demodulating process and before the decode process, and performs the error detection process by comparing the threshold value with the reception quality. Therefore, the reception apparatus 300 can accelerate the error detection process, compared with the case of performing an error correction process by CRC to the reception data and the like after being processed the error correction decode process, by the extent of not performing the error correction decode process or the like. The transmission apparatus 100 can shorten the return period from the packet transmission to the return of the retransmission request, compared with the case of performing the error correction process by CRC. And, by accelerating the error detection process, for example, the reception apparatus 300 can receive large amount of data in a prescribed time period, compared with the case of performing the error correction process by CRC, and thus the radio communication system 10 can enhance the throughput.

### The Third Embodiment

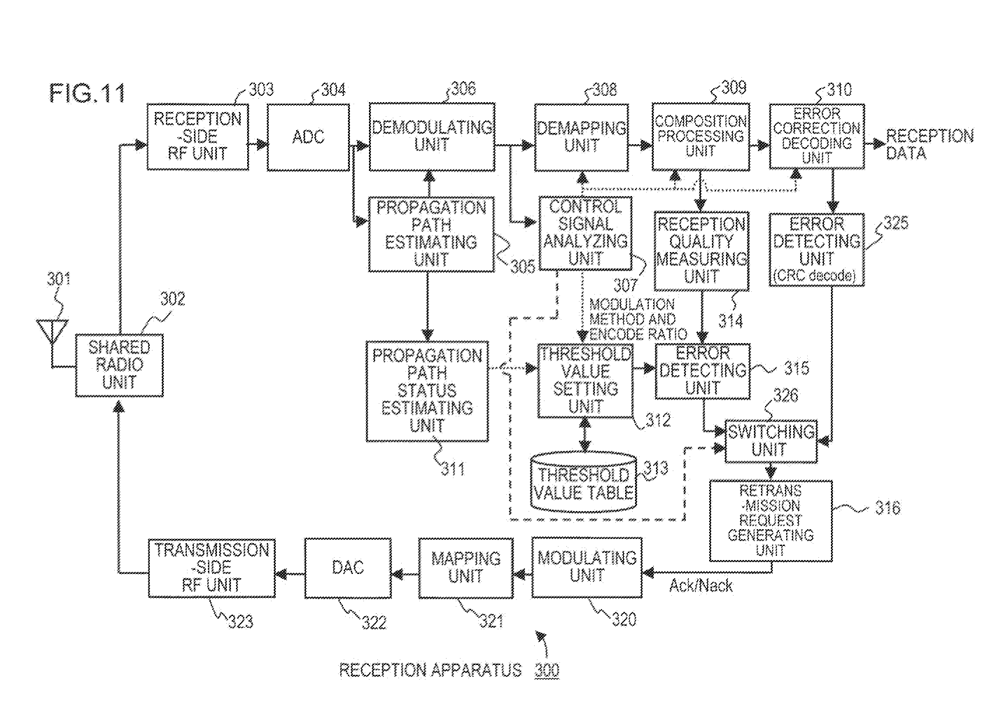

Next, the third embodiment will be explained. The third embodiment relates to an example of error detection, which is a combination of the case in the second embodiment and the error detection by CRC. FIG. 11 illustrates a configuration example of the reception apparatus 300 of the third embodiment. Here, the configuration example of the transmission apparatus 100 is the same as that of the second embodiment (for example, see FIG. 4). Also, as with the second embodiment, an explanation will be carried out on the example such that the transmission apparatus is the base station 100 and the reception apparatus is the mobile station 300.

The reception apparatus 300 further includes a CRC error detecting unit 325 and a switching unit 326.

The CRC error detecting unit 325 decodes CRC code of the reception signal after the error correction decoding, and performs the error detection to the reception data or the like on the basis of the CRC code.

The switching unit 326 outputs to the retransmission request generation unit 316 either of the detection results output from the error detecting unit 315 or the CRC error detecting unit 325, according to the switching signal output from the control signal analyzing unit 307.

The control signal analyzing unit 307, for example, measures or estimates data amount D of the reception data, and calculates estimated delay amount T(D) according to the data amount D. Then, the control signal analyzing unit 307 compares the estimated delay amount T(D) with the retransmission request return period Tᵣₑₜᵤᵣₙ which is threshold value, and outputs switching signal according to the comparison result.

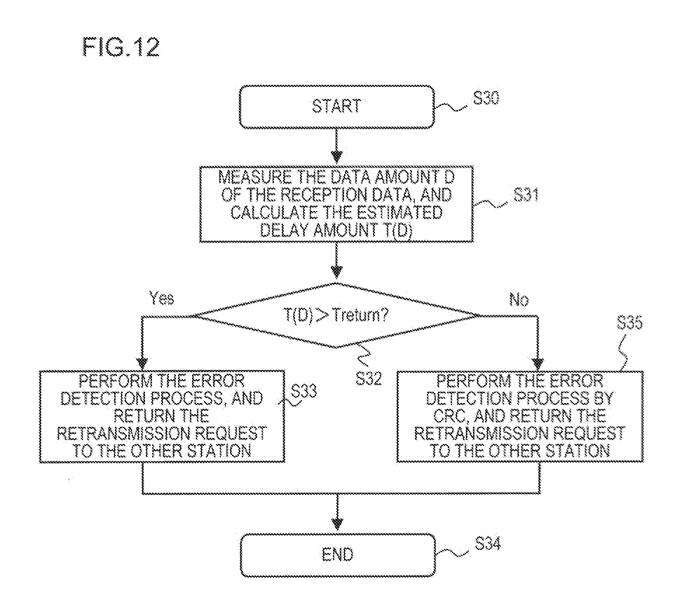

FIG. 12 is a flow chart illustrating an operation example of the third embodiment. The reception apparatus 300 starts the process (S30), measures the data amount D of the reception data, and calculates the estimated delay amount T(D) (S31). For example, the control signal analyzing unit 307 measures the data amount D on the basis of the transmission profile included in the control signal, for example, the modulation method and encode ratio, the band allocated to the reception apparatus 300, or the like, and calculates the estimated delay amount T(D) on the basis of the processing time or the like.

Next, the reception apparatus 300 determines whether or not the estimated delay amount T(D) is greater than the retransmission request return period Tᵣₑₜᵤᵣₙ (S32). For example, the control signal analyzing unit 307 performs the determination by holding the retransmission request return period Tᵣₑₜᵤᵣₙ as the threshold value, and comparing the threshold value with the estimated delay amount T(D).

The reception apparatus 300 performs the error detection process (as illustrated in FIG. 8) (S33), if the estimated delay amount T(D) is greater than the retransmission request return period Tᵣₑₜᵤᵣₙ (“Yes” at S32). For example, the control signal analyzing unit 307 switches the switching unit 326 so that the detection result of the error detecting unit 315 is outputted to the retransmission request generation unit 316. Or, the control signal analyzing unit 307 may power on the reception quality measuring unit 314 and the error detecting unit 315, while powering off the CRC error detecting unit 325. If the estimated delay amount T(D) is greater than the retransmission request return period Tᵣₑₜᵤᵣₙ, for example, that is, if the reception data amount is greater than certain threshold value, the error detecting unit 315 is enabled to perform the error detection so that the delay amount is decreased in the case.

On the other hand, the reception apparatus 300 performs the error detection process by CRC (S35), if the estimated delay amount T(D) is less than or equal to the retransmission request return period Tᵣₑₜᵤᵣₙ (“No” at S32). For example, in such the case, the control signal analyzing unit 307 outputs switching signal so that the switching unit 326 outputs the detection result output from the CRC error detecting unit 325. The control signal analyzing unit 307 may power on the CRC error detecting unit 325, while powering off the reception quality measuring unit 314, the error detecting unit 315, or the like. If the estimated delay amount T(D) is less than or equal to the retransmission request return period Tᵣₑₜᵤᵣₙ, for example, that is, if the reception data amount is less than or equal to the certain threshold value, in such the case, the error detection by CRC is performed so that the delay is small.

The reception apparatus 300 transmits the retransmission request to the transmission apparatus 100 (S33, S35), and then ends the series of processes (S34).

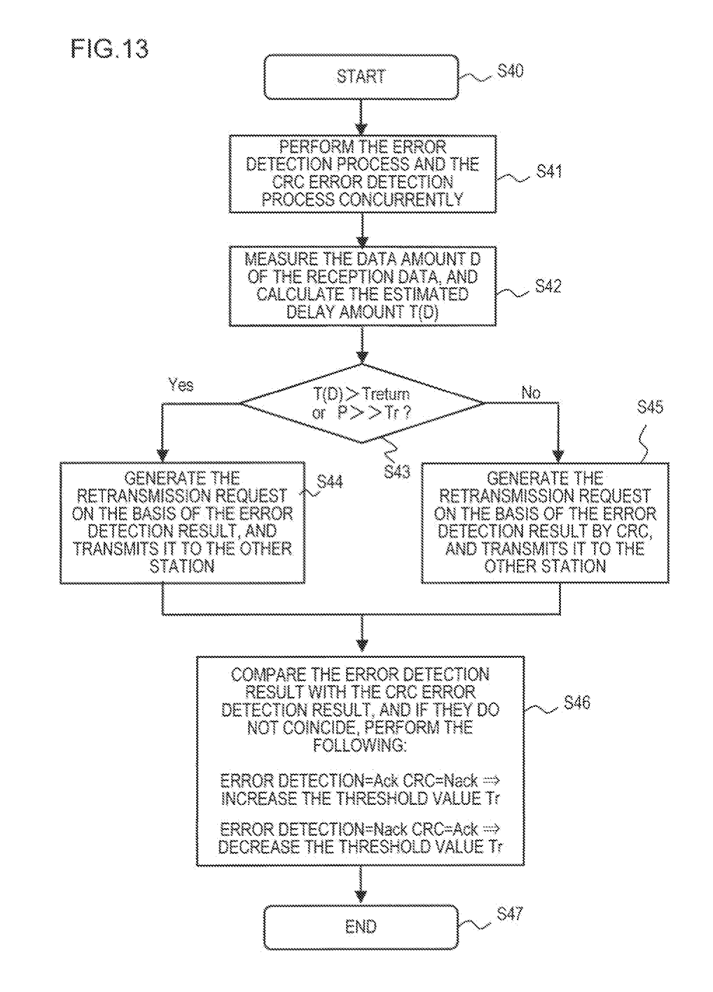

However, in the third embodiment, there may be a case that the detection result of the error detecting unit 315 and the detection result of the CRC error detecting unit 325 do not coincide, depending on the setting of the error threshold value In such the case, to optimize the error threshold value, the reception apparatus 300 may adjust the error threshold value. FIG. 13 is a flow chart for illustrating operation example of such case.

The reception apparatus 300 starts the process (S40), and performs the error detection process and the CRC error detection process concurrently (S41). The reception apparatus 300 performs, for example, error detection process illustrated in FIG. 8, and calculates the reception quality P and the error threshold value Tr.

Next, the reception apparatus 300 estimates the data amount D of the reception data, and calculates the estimated delay amount T(D) (S42).

Next, the reception apparatus 300 determines whether or not the estimated delay amount T(D) is greater than the retransmission request return period Tᵣₑₜᵤᵣₙ, or whether or not the reception quality P is greater than the error threshold value Tr (S43).

If the estimated delay amount T(D) is greater than the retransmission request return period Tᵣₑₜᵤᵣₙ, or if the reception quality P is greater than the error threshold value Tr (“Yes” at S43), the reception apparatus 300 generates the retransmission request on the basis of the error detection result by the error detecting unit 315, and transmits the retransmission request to the transmission apparatus 100 (S44).

On the other hand, if the estimated delay amount T(D) is less than or equal to the retransmission request return period Tᵣₑₜᵤᵣₙ, or if the reception quality P is less than or equal to the error threshold value Tr, the reception apparatus 300 generates the retransmission request on the basis of the CRC error detection result by the CRC error detecting unit 325, and transmits the retransmission request to the transmission apparatus 100 (S45).

The reception apparatus 300 transmits the retransmission request to the transmission apparatus 100 (S44, S45), compares error detection result with the CRC error detection result, and performs the following processes (S46) if these detection results do not coincide. That is, the reception apparatus 300 increases the error threshold value Tr if the error detection result indicates “Ack” and the CRC error detection result indicates “Nack”. On the other hand, the reception apparatus 300 decreases the error threshold value Tr if the error detection result indicates “Nack” and the CRC error detection result indicates “Ack”. By increasing the value of the error threshold value Tr, for example, the reception apparatus 300 have a higher probability to return the Nack, so that the error detection result changes from Ack to Nack and coincides with the CRC error detection result. The error threshold value is adjusted, for example, to coincide with the CRC error detection result. For example, the detection result output to the switching unit 326 is output to the threshold value setting unit 312, and the threshold value setting unit 312 performs the adjustment of the error threshold value Tr.

Then, the reception apparatus 300 ends the series of processes (S47).

In the third embodiment, there may be a case that the retransmission request is transmitted to the transmission apparatus 100 by the processes of the reception quality measuring unit 314 and the error detecting unit 315, and in such the case, as with the second embodiment, the radio communication system 10 can accelerate the error detection process, and thus enhance the throughput.

In the third embodiment, the control signal analyzing unit 307 is explained as to control the switching of the switching unit 326, however, for example, the threshold value setting unit 312 may perform this switching control. In this case, for example, the control signal analyzing unit 307 outputs the transmission profile to the threshold value setting unit 312. And the threshold value setting unit 312 calculates the estimated delay amount T(D) or the like on the basis of the transmission profile, and outputs the switching signal to the switching unit 326.

### The Fourth Embodiment

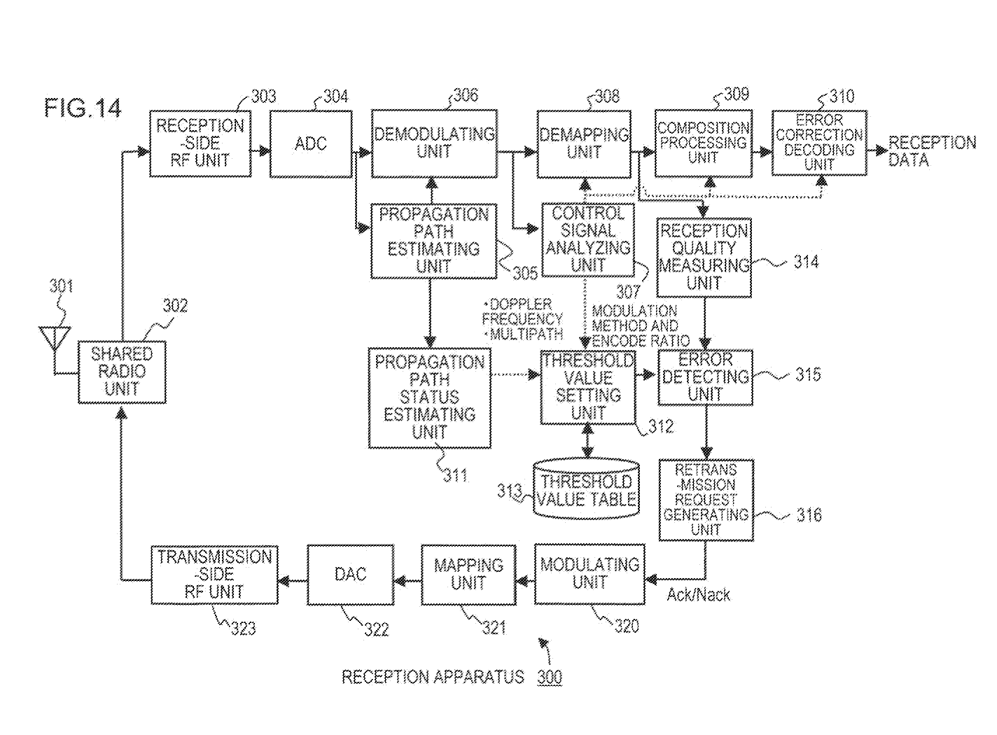

Next, the fourth embodiment will be explained. The fourth embodiment is an example of performing error detection by using the reception data or the like before the composition process. FIG. 14 illustrates a configuration example of the reception unit 300 of the fourth embodiment. This fourth embodiment is explained by an example, as with the second and third embodiments, that the transmission apparatus is the base station 100 and the reception apparatus is the mobile station 300.

The quality measuring unit 314 inputs the reception data or the like output from the demapping unit 308 before input to the composition processing unit 309, and measures the reception quality of the reception data or the like. Or, the quality measuring unit 314 measures the reception quality of the reception data or the like after the demodulating process and before the composition process.

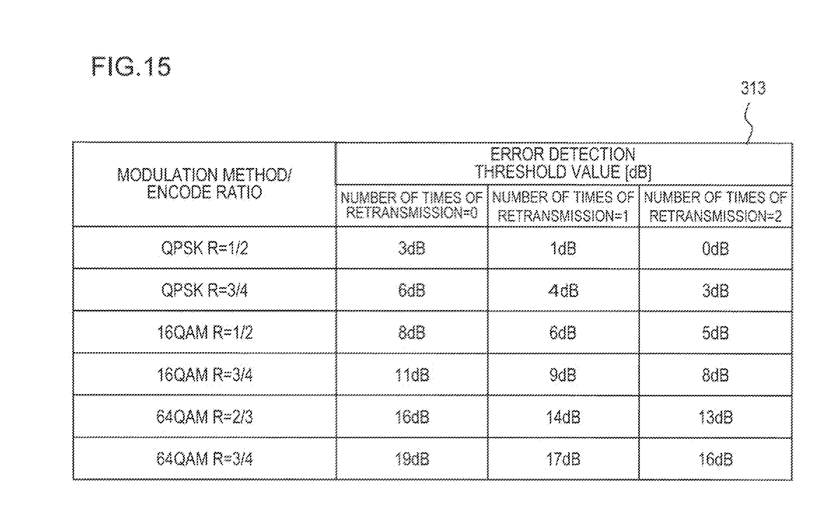

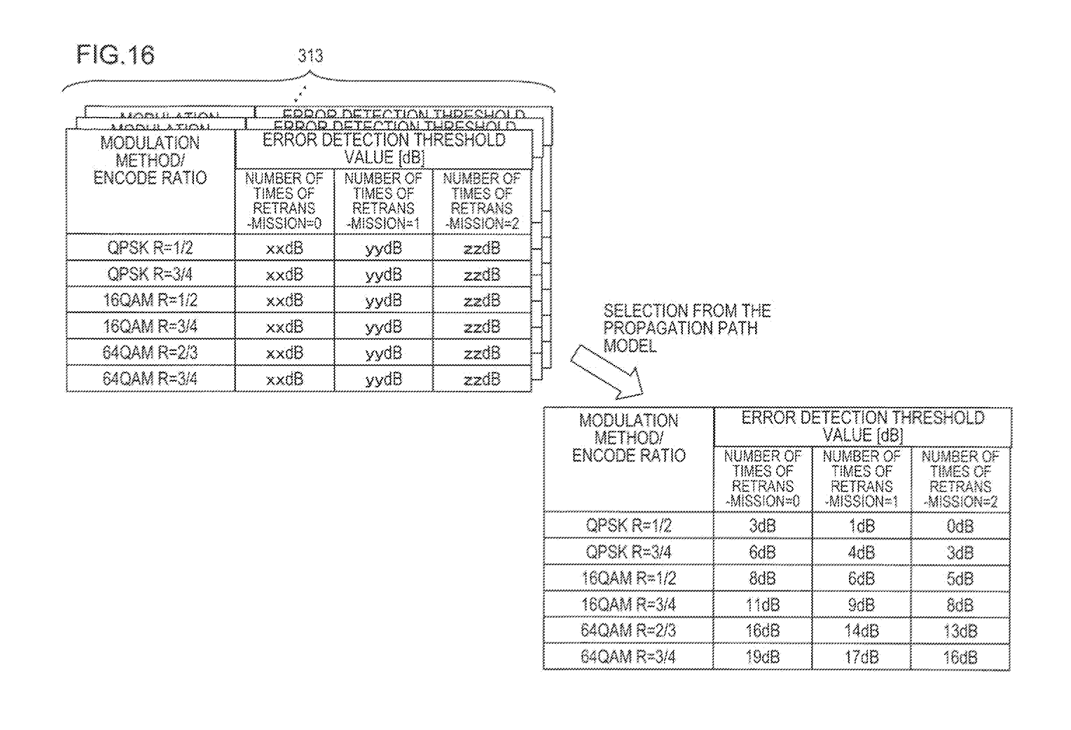

FIG. 15 and FIG. 16 illustrate examples of the threshold value table 313 used in the fourth embodiment. The “Error detection threshold value” which varies according to the number of retransmission times is stored in the threshold value table 313. Since the reception data is less likely to have an error as the number of retransmission times becomes larger, the error threshold value Tr becomes smaller as the number of retransmission times becomes larger. In the threshold value table 313, the different error threshold value according to the number of retransmission times is stored, because the gain of the reception data before the composition process is not maintained large enough compared with the threshold value table 313 of the second embodiment (for example, as illustrated in FIG. 6). Or, it is to enable the reception unit 300 to receive the reception data and return the Ack even if the reception quality of the reception data is not good compared with the certain reception quality.

Here, as illustrated in FIG. 16, the threshold value setting unit 312 selects any of the plurality of the threshold value tables 313 according to the propagation path information (or the propagation path model), as with the second embodiment.

In the fourth embodiment, the reception unit 300 may perform the error detection process in the same manner as the second embodiment, by the quality measuring unit 314 performing process for inputting the reception data output from the demapping unit 308, instead of the maximum ratio composition process (for example, S12 of FIG. 8). The reception apparatus 300 may also correct the error threshold value Tr (for example, as illustrated in FIG. 9). Therefore, the radio communication system 10 in the fourth embodiment also can accelerate the error detection process and enhance the throughput.

### The Fifth Embodiment

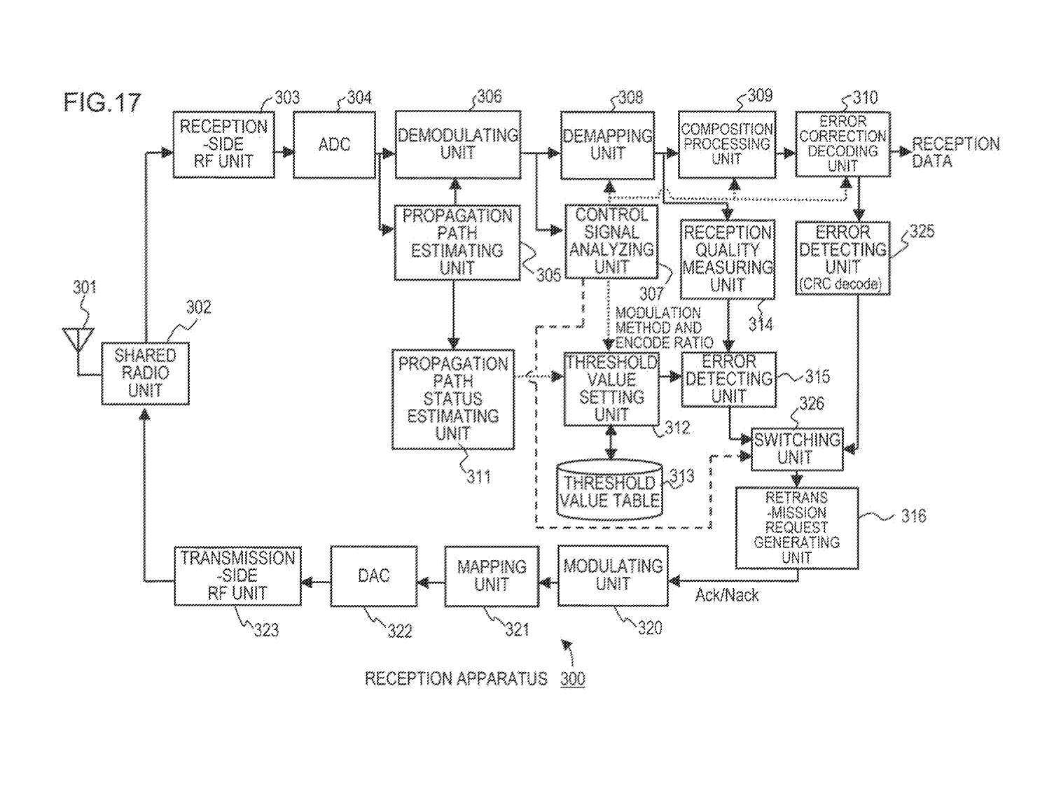

Next, the fifth embodiment will be explained. The fifth embodiment is an example of a combination of the third and the fourth embodiments. FIG. 17 illustrates a configuration example of the reception apparatus 300 of the fifth embodiment. The configuration of the transmission apparatus is illustrated in FIG. 4. The examples of the threshold value table 313 are illustrated in FIG. 15 and FIG. 16.

The reception quality measuring unit 314, as with the fourth embodiment, inputs the reception data before the composition process and measures the reception quality on the basis of the reception data.

Also, the control signal analyzing unit 307, as with the third embodiment, compares the estimated delay amount T(D) with the retransmission request return period Tᵣₑₜᵤᵣₙ, and outputs the switching signal according to the comparison result. The switching unit 326 switches either of the output from the error detecting unit 315 or the output from the CRC error detecting unit 325 (for example, see FIG. 12 or FIG. 13), on the basis of the switching signal.

By the fifth embodiment, as well as the third embodiment, the radio communication system 10 can accelerate the error detection process and enhance the throughput.

### The Sixth Embodiment

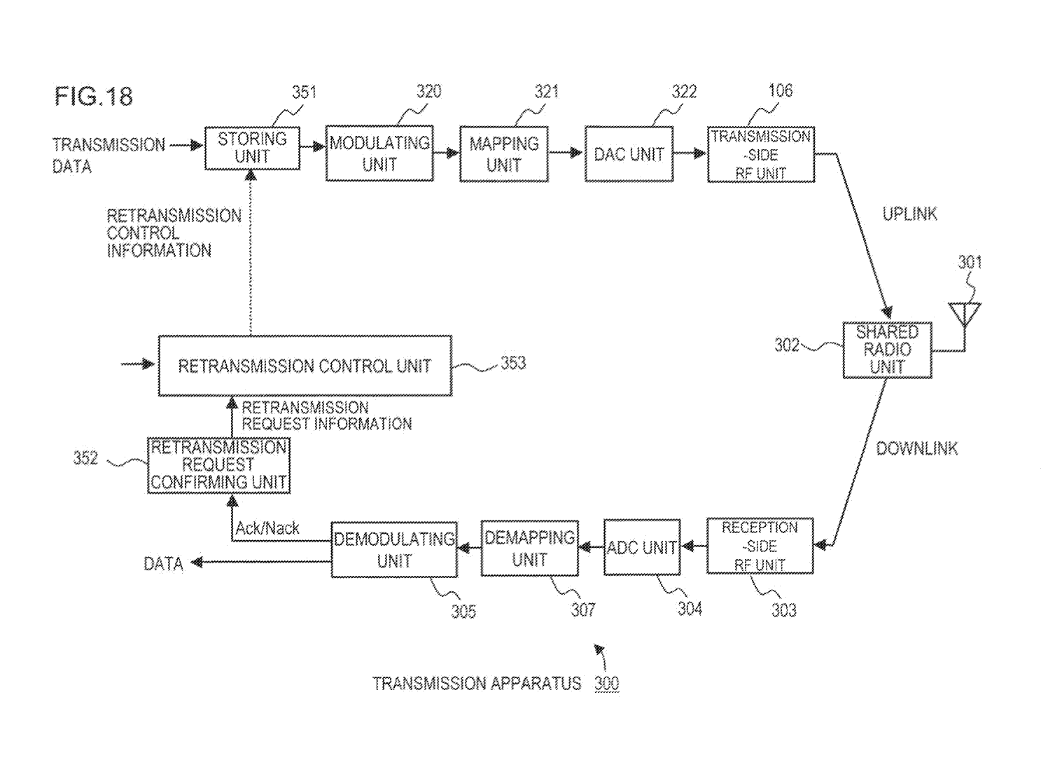

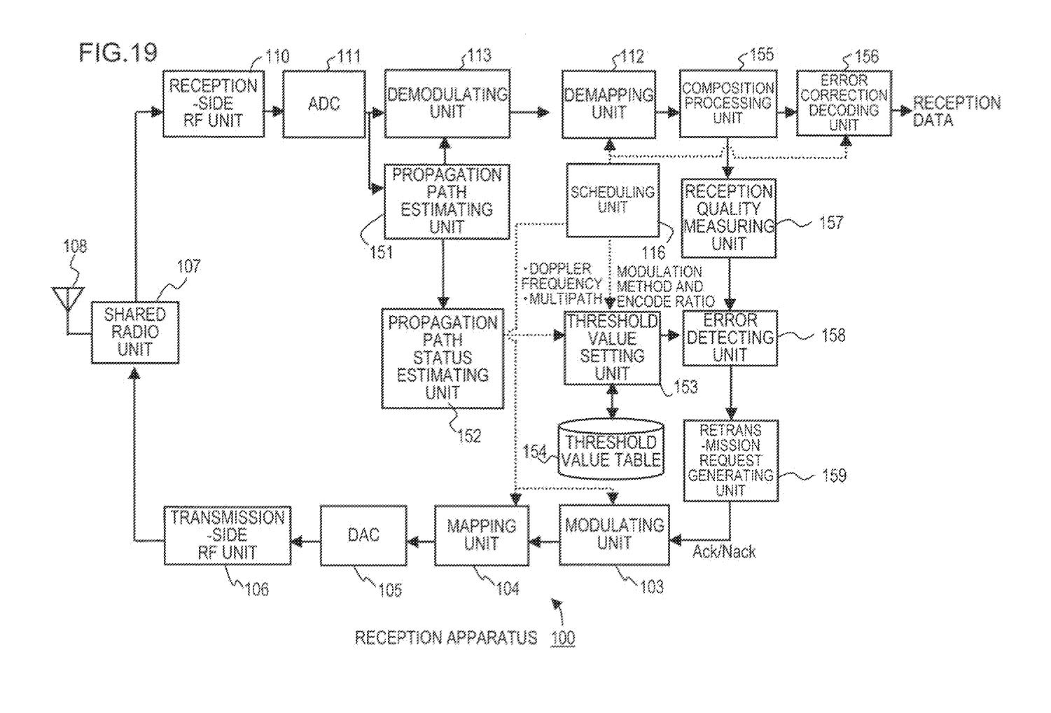

The first through fifth embodiments relate to the downlink, which is explained by the example that the transmission apparatus is the base station 100 and the reception apparatus is the mobile station 300. The sixth embodiment relates to the uplink, which will be explained by examples that the transmission apparatus is the mobile station 300 and the reception apparatus is the base station 100, that the transmission apparatus is the mobile station 300 and the reception apparatus is the relay station 200, and that the transmission apparatus is the relay station 200 and the reception apparatus is the base station 100. FIG. 18 and FIG. 19 illustrate each configuration example of the case that the transmission apparatus is the mobile station 300 and the reception apparatus is the base station 100.

The transmission apparatus 300 further includes a storing unit 351, a retransmission request confirming unit 352, and a retransmission control unit 353.

The storing unit 351 stores the transmission data, and confirms whether or not the retransmission data is to be transmitted on the basis of the retransmission control information. Then, the storing unit 351 outputs the stored retransmission data in case of the retransmission, or the new transmission data in case of not retransmission, to the modulation processing unit 320.

The retransmission request confirming unit 352 confirms the retransmission request signal (the Ack signal or the Nack signal) which is transmitted from the reception apparatus 100 and output from the demodulating unit 306, and outputs the retransmission request information to the retransmission control unit 354.

The retransmission control unit 353 generates the retransmission control information on the basis of the retransmission request information, and outputs to the storing unit 351. For example, the retransmission control unit 353 generates the retransmission control information indicating that the new data is to be transmitted if the retransmission request information indicates the Ack, and generates the retransmission control information indicating that the stored retransmission data is to be transmitted if the retransmission request information indicates the Nack. Or, the retransmission data from the storing unit 351 and the new data is transmitted by controlled by the retransmission control unit 353.

The reception apparatus 100 further includes a propagation path estimating unit 151, a propagation path status estimating unit 152, a threshold value setting unit 153, a threshold value table 154, a composition processing unit 155, an error correction decoding unit 156, a reception quality measuring unit 157, an error detecting unit 158, and a retransmission request generating unit 159.

The propagation path estimating unit 151 performs the propagation path estimation, for example, on the basis of the pilot signal or the like of uplink reception signal output from the ADC unit 111, generates the propagation estimation information, and outputs to the propagation path state estimating unit 152.

The propagation path status estimating unit 152 generates the propagation path information such as the Doppler frequency, the multi path status, or the like, on the basis of the propagation path estimation information, and outputs to the threshold value setting unit 153.

The threshold value setting unit 153 sets the error threshold value on the basis of the propagation path information and reception profile (for example, the modulation method, the encode ratio, or the like) scheduled by the scheduling unit 116. The threshold value setting unit 153 sets the error threshold value to be adopted for the robustness (or the ease of error) of the uplink reception data.

The threshold value table 154, as well as the second embodiment, for example, stores the error threshold value corresponding to the modulation method and the encode ratio. Examples of the threshold value table 154 are illustrated in FIG. 6 and FIG. 7. As illustrated in FIG. 7, The threshold value table 154 is the selected table by any of the plurality of tables on the basis of the propagation path information.

The composition processing unit 155 performs the maximum ratio composition with the reception data subject to the retransmission, if the reception data or the like output from the demapping unit 112 is the retransmission data. The composition processing unit 155 can determine whether the reception data is the retransmission data or the new data, for example, on the basis of the retransmission request signal output from the retransmission request generating unit 159. The composition processing unit 155 outputs the reception data without composition if the reception data is not the retransmission data.

The error correction decoding unit 156 performs the error correction decode process on the reception data output from the composition processing unit 155 on the basis of the reception profile (for example, the encode ratio or the like) from the scheduling unit 116.

The reception quality measuring unit 157 measures the reception quality, for example, the EVM or the CINR of the reception data or the like. The reception quality measuring unit 157, for example, measures the reception quality of the reception data or the like after the demodulation process and before the decode process, as with the second embodiment.

The error detecting unit 158, as well as the error detecting unit 315 of the second embodiment, compares the threshold value with the reception quality, and detects the error of the reception data or the like. The error detecting unit 158 performs, for example, the processes illustrated in FIG. 8.

The retransmission request generating unit 159 generates on the basis of the detection result of the error detecting unit 158 the Ack signal or the Nack signal, and outputs either of them to the modulating unit 103. The retransmission request signal is transmitted, for example, from the base station 100 to the mobile station 300.

As well as the third embodiment, the reception apparatus 100 can be in practice in the combination with the error detection by the CRC decoding (for example, as illustrated in FIG. 12 and FIG. 13). Or, as well as the fourth embodiment, the reception apparatus 100 can measure the reception quality of the reception data or the like before the composition process. In this case, for example, the threshold value table 154 is illustrated in FIG. 16 and the rest. Further, as well as the fifth embodiment, the reception apparatus 100 can be in practice in the combination of the third and the fourth embodiments.

As for the radio communication system 10, the reception apparatus 100 also measures the reception quality on the basis of the reception data before the error correction decode process, and performs the error detection by comparing the reception quality with the threshold value. Therefore, in the sixth embodiment, as well as the second embodiment, for example, the radio communication system 10 can accelerate the error detection process and enhance the throughput.

### Other Embodiments

In the first through sixth embodiments described above, the transmission method of the transmission apparatus and the reception apparatus can be performed in a method of OFDM (Orthogonal Frequency Division Multiplexing), CDMA (Code Division Multiple Access), TDMA (Time Division Multiple Access), FDMA (Frequency Division Multiple Access), or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention has been described in detail, it should be understood that the various changes, substitutions, and alterations could be made hereto without departing from the spirit and scope of the invention.

1. A radio communication apparatus for performing radio communicate with other radio communication apparatus, the radio communication apparatus comprising:
a quality measuring unit which measures reception quality of reception signal which is received from the other radio communication apparatus;
a first error detecting unit which detects an error of reception data included in the reception signal on the basis of the reception quality and a first threshold value; and
a retransmission request signal generating unit which generates a retransmission request signal on the basis of an error detection result of the first error detection unit, and transmits the retransmission request signal to the other radio communication apparatus.

2. The radio communication apparatus according to claim 1, further comprising a threshold value setting unit which determines the first threshold value on the basis of transmission profile for the reception data, and outputs the first threshold value to the first error detecting unit.

3. The radio communication apparatus according to claim 2, wherein the threshold value setting unit determines the first threshold value on the basis of propagation path status and the transmission profile.

4. The radio communication apparatus according to claim 3, wherein the threshold value setting unit corrects the determined first threshold value on the basis of interference amount or reception deterioration amount.

5. The radio communication apparatus according to claim 1, wherein the quality measuring unit measures the transmission quality by measuring CINR (Carrier to Interference plus Noise Ratio) or EVM (Error Vector Magnitude) of the reception signal.

6. The radio communication apparatus according to claim 1, further comprising
a second error detecting unit which detects an error of the reception data by using CRC code which is included in the reception signal and is after an error correction decoding, wherein
the retransmission request signal generating unit generates the retransmission request signal on the basis of the error detection result of the first error detecting unit or an error detection result of the second error detecting unit.

7. The radio communication apparatus according to claim 6, further comprising:
an estimated delay measuring unit which measures an estimated delay amount corresponding to data amount of the reception data; and
a switching unit which outputs to the retransmission request signal generating unit either one of the error detection result of the first error detecting unit or the error detection result of the second error detecting unit, on the basis of the estimated delay amount; wherein
the switching unit outputs the detection result output from the first error detecting unit if the estimated delay amount is greater than the second threshold value, or outputs the detection result output from the second error detecting unit if the estimated delay amount is less than or equal to the second threshold value.

8. The radio communication apparatus according to claim 6, wherein the threshold value setting unit adjusts the first threshold value if the detection results of the first and second error detecting unit do not coincide.

9. The radio communication apparatus according to claim 1, wherein the radio communication apparatus is a base station apparatus, a mobile station apparatus, or a relay station apparatus.

10. The radio communication apparatus according to claim 1, wherein the quality measuring unit measures the transmission quality of the reception signal before an error correction decode process is performed to the reception signal.

11. The radio communication apparatus according to claim 2, wherein the transmission profile includes modulation method or encode ratio to the reception signal.

12. The radio communication apparatus according to claim 3, further comprising
a threshold value table which stores the first threshold value, wherein
the threshold value setting unit selects any one of a plurality of the threshold value tables on the basis of the propagation path status information, reads out the first threshold value corresponding to the transmission profile from the selected threshold value table, and outputs to the error detecting unit.

13. The radio communication apparatus according to claim 1, wherein the first error detecting unit outputs a detection result indicating occurrence of error if the reception quality is greater than the first threshold value, or outputs a detection result indicating occurrence of no error if the reception quality is less than or equal to the first threshold value.

14. The radio communication apparatus according to claim 4, wherein the reception deterioration amount is an amount according to mobile velocity of the radio communication apparatus.

15. The radio communication apparatus according to claim 1, further comprising
a composition processing unit which composes with the reception data subject to retransmission and retransmission data, if the reception data is the retransmission data, wherein
the quality measuring unit measures the transmission quality of the composed reception data.

16. The radio communication apparatus according to claim 1, wherein the quality measuring unit measures the transmission quality of the reception data subject to retransmission and the retransmission data before the composition process is performed.

17. The radio communication apparatus according to claim 16, further comprising
a second error detecting unit which detects error of the reception data by using CRC code which is included in the reception data and is after error correction decoding, wherein
the retransmission request signal generating unit generates the retransmission request signal on the basis of the error detection result of the first error detecting unit or error detection result of the second error detecting unit.

18. A radio communication system comprising:
a first radio communication apparatus; and
a second radio communication apparatus, wherein
the first and second communication apparatus perform radio communication,
the first radio communication apparatus includes:
a quality measuring unit which measures a transmission quality of reception signal received from the second radio communication apparatus,
a first error detecting unit which detects error of reception data included in the reception signal on the basis of the transmission quality and a first threshold value, and
a retransmission request signal generating unit which generates retransmission request signal on the basis of detection result of the first error detecting unit, and transmits the retransmission request signal to the second radio communication apparatus, and wherein
the second radio communication apparatus includes a transmission unit which retransmits the reception data according to the retransmission request signal.

19. A radio communication method in a radio communication system for performing radio communication between a first radio communication apparatus and a second communication, the method comprising:
measuring transmission quality of reception signal received from the second radio communication apparatus, detecting error of reception data included in the reception signal on the basis of the transmission quality and a first threshold value, generating retransmission request signal on the basis of detection result of the error detecting, and transmitting the retransmission request signal to the second radio communication apparatus, in the first radio communication apparatus;
retransmitting the reception data according to the retransmission request signal, in the second radio communication apparatus.
